(19) United States
(12) Patent Application Publication
(10) Pub. No.: US 2012/0308895 A1
(43) Pub. Date: Dec. 6, 2012

(54) ELECTRODE COMPOSITIONS USEFUL FOR ENERGY STORAGE DEVICES AND OTHER APPLICATIONS; AND RELATED DEVICES AND PROCESSES

(75) Inventors: Richard Louis Hart, Broadalbin, NY (US); Michael Alan Vallance, Loudonville, NY (US); David Charles Bogdan, Scotia, NY (US)

(73) Assignee: General Electric Company, Schenectady, NY (US)

(21) Appl. No.: 13/149,617

(22) Filed: May 31, 2011

(51) Int. Cl. H01M 4/58; H01M 6/00; H01M 4/36

(52) U.S. Cl. 429/231.9; 252/182.1; 29/623.1

(57) ABSTRACT

A positive electrode composition is described, containing granules of at least one electroactive metal and at least one alkali metal halide. The granules have a substantially spheroidal shape. An energy storage device and an uninterruptable power supply device are also described. They include compartments for positive and negative electrode compositions; a solid separator capable of transporting alkali metal ions between the compartments; and associated current collectors for the electrodes. The positive electrode composition contains substantially spheroidal granules. Related methods for the preparation of an energy storage device are also disclosed.

### BACKGROUND OF THE INVENTION

This invention relates generally to electrode compositions. In some specific embodiments, the invention relates to positive electrode compositions that can be incorporated into energy storage devices such as batteries; and uninterruptable power supply (UPS) devices.

Metal chloride batteries, especially sodium-metal chloride batteries with a molten sodium negative electrode (usually referred to as the anode) and a beta-alumina solid electrolyte, are of considerable interest for energy storage applications. In addition to the anode, the batteries include a positive electrode (usually referred to as the cathode) that supplies/receives electrons during the charge/discharge of the battery. The solid electrolyte functions as the membrane or “separator” between the anode and the cathode. When these metal chloride batteries are employed in mobile applications like hybrid locomotives or plug-in electric vehicles (PHEV), the batteries are often capable of providing power surges (high currents), during discharging of the battery. In an ideal situation, the battery power can be achieved without a significant loss in the working capacity and the cycle life of the battery.

Those familiar with these types of energy storage devices understand that the positive electrode plays a critical role in determining the power/energy characteristics of the battery, including its electrical resistance profile. Very often, the positive electrode includes multiple components, each having specific functions. For example, the positive electrode can include both an electrode material and a support structure. The electrode material functions as an electrochemical reactant, in both the oxidized and reduced state, or in any intermediate state. The support structure for the positive electrode does not undergo any significant chemical reaction during charge/discharge, but does support the electrode material during the electrochemical reaction, functioning as a surface upon which any solids may precipitate. (The support structure also functions as a conductor of electrons through the cathode). Most often, the positive electrode also contains an electrolyte material that allows ion transport between the positive and negative electrodes of a cell, and may act as a solvent for the oxidized form of the electrode material.

In many cases, the positive electrode composition is prepared by combining powders of the various constituents, e.g., powders of electroactive metals and of alkali metal halides, as described further below. Using high-pressure methods, the powders are usually compacted into a brittle tape, e.g., a “green tape”. The tape is then broken up into irregularly-shaped, millimeter-size agglomerates. The agglomerates can then be sized by various techniques, so as to segregate materials of a preferred size, prior to being loaded into a cathode chamber with the electrolyte. In some instances, the cathode chamber may contain about 50% agglomerates (e.g., containing perhaps equal amounts of metals and salts); and about 50% of molten electrolyte material, by volume.

There continues to be a growing need in the art for metal chloride batteries with higher performance profiles. The performance can be expressed by way of various attributes, such as power density, energy density, battery life, or charge density. The required attributes will of course depend on the end use of the battery or other type of energy storage device, since different applications may have dramatically different performance requirements. More specifically, the positive electrode composition in the energy storage device may play a very significant role in the enhancement of selected attributes for a given end use.

### BRIEF DESCRIPTION OF THE INVENTION

One embodiment of the invention is directed to a positive electrode composition. The composition comprises granules of at least one electroactive metal and at least one alkali metal halide. The granules have a substantially spheroidal shape, as described below. An article that comprises such a positive electrode constitutes another embodiment of the invention.

Another embodiment is directed to an energy storage device or an uninterruptable power supply device. The device comprises:

a) a first negative compartment comprising an alkali metal;

b) a negative electrode current collector

c) a second compartment comprising a positive electrode composition that itself comprises granules of at least one electroactive metal and at least one alkali metal halide, wherein the granules have a substantially spheroidal shape;

d) a positive electrode current collector; and

e) a solid separator capable of transporting alkali metal ions between the first and the second compartments.

Another embodiment of the invention is directed to method for the preparation of an energy storage device, comprising the steps of

A) providing a positive electrode and a negative electrode, ionically connected to each other by a separator, and capable of reacting galvanically upon connection;

B) providing an electrically-conductive electrolyte to at least the positive electrode; and

C) providing positive and negative current collectors for attachment to the positive and negative electrodes, respectively, to direct current resulting from the galvanic reaction to a desired location;

wherein the positive electrode comprises granules having a substantially spherical shape.

### BRIEF DESCRIPTION OF THE DRAWINGS

FIGS. 1, 2 and 3 are a depiction of spheroidal granules for an electrode composition.

FIGS. 4, 5 and 6 are a depiction of granules for an electrode composition, after a period of spheronization.

FIGS. 7, 8 and 9 are a depiction of granules for an electrode composition, prior to any spheronization.

FIG. 10 is a schematic, cross-sectional view of a portion of an electrochemical cell for some embodiments of the present invention.

FIG. 11 is another schematic, cross-sectional view of an electrochemical cell for embodiments of this invention.

FIGS. 12, 13, and 14 are photomicrographs of granules for an electrode composition, before and after spheronization.

FIG. 15 is a plot of packing density versus spheronization time for electrode granules.

FIG. 16 is a plot of electrochemical cell voltage as a function of charge capacity, for granules used as the positive electrode composition in a cell.

### DETAILED DESCRIPTION OF THE INVENTION

Each embodiment presented below facilitates the explanation of certain aspects of the invention, and should not be interpreted as limiting the scope of the invention. Moreover, approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

In the following specification and claims, the singular forms “a”, “an” and “the” include plural referents unless the context clearly dictates otherwise. As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

For most end use applications, the positive electrode composition comprises at least one electroactive metal selected from the group consisting of titanium, vanadium, niobium, molybdenum, nickel, cobalt, chromium, copper, manganese, silver, antimony, cadmium, tin, lead, iron, and zinc. Combinations of any of these metals are also possible. In some specific embodiments, the electroactive metal is nickel, iron, copper, zinc, cobalt, chromium, or some combination thereof. Very often, nickel is the most preferred electroactive metal, in view of various attributes. They usually include cost, availability, the relatively high reduction potential (“redox potential”) of nickel, relative to sodium; and the relatively low solubility of the nickel cation in the reaction-catholyte. Usually, the metals are obtained as powders from various commercial sources.

Typically, the positive electrode composition also comprises at least one alkali metal halide to promote the desired electrochemical reaction for the device of interest. Halides of sodium, potassium, or lithium are possible. In some preferred embodiments, the composition comprises at least sodium chloride. In other embodiments, the composition comprises sodium chloride and at least one of sodium iodide and sodium fluoride. Some specific positive electrode compositions are described in copending application Ser. No. 13/034,184 (D. Bogdan et al; filed Feb. 24, 2011 for the Assignee of this case; and incorporated herein by reference). In some specific embodiments, sodium iodide, when present, is at a level of about 0.1 weight percent to about 0.9 weight percent, based on the weight of the entire positive electrode composition.

In addition to the electrolyte salt discussed below, the positive electrode composition may include a number of other constituents. As an example, aluminum may be included, i.e., in a form other than its form in the electrolyte salt, and other than as an aluminum halide. In other words, the aluminum would usually be in elemental form, e.g., aluminum metal flakes or particles. The aluminum may assist in improving the porosity of the cathode granules described below. In some embodiments, the amount of elemental aluminum present in the positive electrode composition is in a range from about 0.2 volume percent to about 0.5 volume percent, based on the volume of the positive electrode composition. In another embodiment, the amount of aluminum present in the positive electrode composition is in a range from about 0.25 volume percent to about 0.45 volume percent.

In one embodiment, the positive electrode composition may further comprise sulfur, in the form of molecular sulfur or a sulfur-containing compound. If present, the level of sulfur is usually in the range from about 0.1 weight percent to about 3 weight percent, based on the total weight of the positive electrode composition. However, as described in application Ser. No. 13/034,184, it is sometimes preferred that the positive electrode be substantially free of sulfur, i.e., containing, at most, impurity levels.

The positive electrode composition may include other additives that beneficially affect the performance of an energy storage device. Such performance additives may increase ionic conductivity, increase or decrease solubility of the charged cathodic species, improve wetting of a solid electrolyte, i.e., the separator, by the molten electrolyte; or prevent ripening of the positive electrode micro-domains, to name several utilities. Usually, though not always, the performance additive is present in an amount that is less than about 1 weight percent, based on the total weight of the positive electrode composition. Examples of such additives include one or two additional metal halides, e.g., sodium fluoride or sodium bromide.

As mentioned above, the positive electrode includes granules of the electroactive metal(s) and the alkali metal halide(s); and those granules have a substantially spheroidal shape. As used herein, the term “spheroidal” is meant to describe a body that is generally shaped like a sphere, but may not be “perfectly” round. In other words, a perfect sphere is completely symmetrical around its center, with all points on the surface lying the same distance/radius “r” from the center of the sphere. In the present instance, the “r” distance may differ somewhat in different directions from the center of the sphere. Included within the definition of “spheroidal” for this invention are ellipsoid granules, i.e., granules which present principal cross-sections generally in the shape of an ellipse, as that term is known in the art. (In some embodiments, all of the granules are substantially spherical).

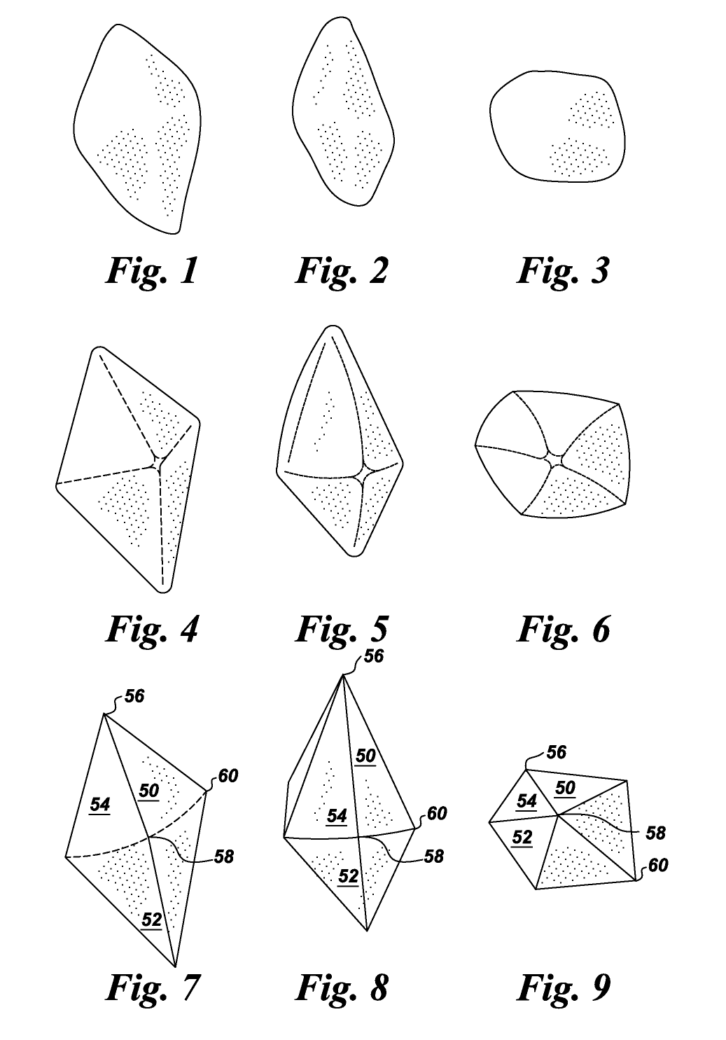

FIGS. 1, 2, and 3 depict granules that are generally spheroidal. Each figure provides a non-limiting example of a spheroid having a different aspect ratio. As those skilled in the art understand, a sphere, in 3 dimensions, occupies a volume V represented by the equation

V=4/3πr³ (I),

wherein “r” is as described above. FIGS. 4, 5 and 6 depict granules (in three different aspect ratios) that are not quite as spheroidal as those of FIGS. 1,2 and 3, and might be thought of as ellipsoidal or somewhat ellipsoidal in shape.

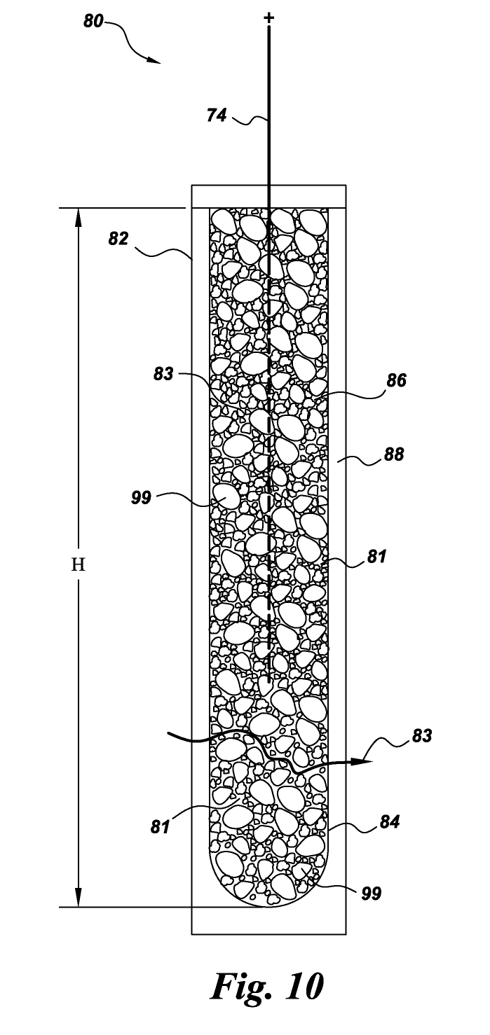

In most embodiments (though not all), the granules have been transformed into a spheroidal shape by a spheronization process, as further described below. The process effectively removes any sharp angles or jagged edges from the granules. As an illustration, FIGS. 7, 8, and 9 (outside this inventive scope) depict granules that do possess sharp angles and/or jagged edges, with three different aspect ratios illustrated. Such granules are typically prepared by the powder-compacting techniques mentioned previously. The compacted powder is typically formed into a brittle tape, which is then broken up to form these granules.

In some instances, the granules in FIGS. 7, 8, and 9 have a shape similar to that of uncut diamonds. A number of faces 50, 52, and 54 generally intersect at one or more vertices 56, 58, and 60. While the faces may be relatively flat, they can also be rough and irregular, depending on the manner in which the granules have been produced and handled.

A number of conventional techniques can be used to form the granules of the present invention, having the substantially spheroidal shape. Many of the techniques would be suitable for the treatment of granules that initially have a non-spheroidal shape, e.g., like that of FIGS. 7, 8, and 9. Non-limiting examples include abrasion techniques, e.g., with a spinning disc; wet powder tumbling/agglomeration; and roll-milling (e.g., with an abrasive media). Roll compacting may also be employed, using roller surfaces that are designed to form spherical shapes in particles or granules moving through the rollers. Some of these techniques are well-known in the pharmaceutical industry, for preparing particles, beads, and the like, in spherical form. The techniques are applicable to both organic and inorganic (e.g., ceramic/metallic) materials.

Spheronization is a useful technique for preparing the granules. This type of technique (sometimes referred to as “marumerization”), is described, for example, in U.S. Pat. No. 5,350,584 (McClelland et al) and U.S. Pat. No. 5,049,394 (Howard et al), both incorporated herein by reference. Various techniques are also described by Nikhil P. Jogad, “A review: MUPS by extrusion spheronization Technique”, Journal of Pharmacy Research 2010, 3(8), 1793-1797, which is also incorporated herein by reference.

According to some conventional designs, the spheronizer includes a rotating friction disk, designed to increase friction with the granular material. The disk spins at relatively high speeds, at the bottom of a cylindrical bowl. The spinning friction disc has a specifically-designed groove pattern on the processing surface. The surface is most often cross-hatched, but several sizes and other types are available. (A helpful description is also provided at http://www.spheronizer.com/html/spheronization.html).

Granules of a desired size (e.g., as provided by screen-sizing and the like; and usually having the sharp edges described above) are directed into the spheronizer device. The ongoing action of the granules colliding with the wall of the bowl, and being thrown back to the inside of the plate, creates a “rope-like” movement of product along the bowl wall. The continuous collision of the granules with the wall and with the friction plate gradually transforms the granules into spheres or spheroids. When the particles have obtained the desired spheroidal shape, the discharge valve of the chamber is opened and the granules are discharged by the centrifugal force. Those skilled in the art understand that the spheronizer can be modified for a given application, and for a wide variety of particle compositions, shapes, densities, and the like. Moreover, the details regarding the use of the other techniques noted above are also understood by those skilled in the art. Furthermore, it may also be possible to obtain the spheroidal granules from a commercial source; and/or from a technique other than spheronization.

The size of the granules may vary to some extent, based on a number of factors, such as their porosity (discussed below); the required energy density for a device in which the electrode is incorporated; and the size and shape of the electrode.

For the purpose of this description, the size of the granule is measured along its largest dimension, regardless of whether the shape is closer to being spherical, or closer to being elliptical. A convenient way to express the size is by way of the granule's effective diameter “D_{g}”, which can be expressed as

D_{g}=(6V_{g}/π)^{1/3} (II),

wherein V_{g} is the volume of the granule. In general, the effective diameter of the granules is usually in the range of about 100 microns to about 5,000 microns. In some specific embodiments, the range is between about 250 microns and about 3,000 microns. Methods for determining the size of granules and other types of particles are known in the art, e.g., the use of commercial particle size analyzers, as described in U.S. Pat. No. 7,247,407.

In some embodiments, the granules for the positive electrode composition are present as a multi-modal distribution. For example, the granules may generally conform to a bimodal distribution, in which granule size (diameter) is concentrated around two separate particle sizes. As an illustration for a bimodal situation, it is sometimes preferable that the ratio of the diameters (weight-average) is in a range from about 1 to 0.1, to about 1 to 0.005. The ratio of the weight fractions of the granule fractions can be in the range of about 0.5 (larger particles) to about 0.5 (smaller particles); up to a range of about 0.95 (larger particles) to about 0.05 (smaller particles). This type of distribution can sometimes greatly improve the packing density of the granules, within a positive electrode container.

In conjunction with other cathode characteristics, the porosity of the granules can affect the electrical characteristics of this electrode, e.g., its resistance profile. (This porosity is sometimes referred to as the “internal porosity” within the cathode structure). For most applications, some porosity within the granules is desirable. As an example, a porosity (measured under the discharge-state of the device) is usually between about 5% and about 30%, although in some cases, there may be no significant porosity, i.e., 0%. The internal porosity of the granules can be measured by a number of techniques, e.g., use of a commercial porosimeter. The internal porosity can be controlled by various techniques. As an example, when the granules are formed by a roller-based compaction method, as mentioned above, adjustments in material feeding speed and roller pressure can be used to control internal porosity.

The porosity between granules within the cathode (i.e., a cathode compartment, as described below) can also be a very important consideration for embodiments of this invention. FIG. 10 is illustrative in this regard, depicting a simplified view of an article 80, which may be used as an electrochemical cell. The article includes a housing 82 and a separator 84, separating an inner chamber 86 and an outer chamber 88. (A positive current collector 74 is partially shown, extending into chamber 86).

The inner chamber 86 can be a chamber for the positive electrode composition, e.g., the cathode chamber/cathode electrode. Granules 99 of the electrode composition are shown, partially filling chamber 86. These granules conform to embodiments of this invention, i.e., having a spheroidal shape. (The relative size of the granules may vary significantly, and this figure is merely illustrative). The region 81 represents the area of porosity between the granules, and is referred to herein as the “external porosity”. (In preparing an electrochemical cell, both the internal and external porosity is usually filled with a liquid electrolyte, such as molten sodium aluminum chloride (NaAlCl₄)).

The external porosity can vary greatly, e.g., from about 25% to about 70%, depending on the ultimate use of the article, e.g., the particular application for the energy storage device. For example, high-power applications such as some of the UPS systems (discussed below) may be enhanced by a relatively high porosity with the range noted above. In such a case, the granules may be somewhat “unpacked”, resting relatively high up within the height (“H”) of chamber 86.

In other applications, the porosity should be relatively low. This permits the “packing in” of a much greater amount of granules. The greater concentration of granules can contribute greatly to the energy density of a positive electrode composition used for an energy storage device. In this case, the external porosity is usually in the range of about 20% to about 50% (as measured at full discharge of the cell; and excluding any porosity within the granules). In some preferred embodiments for these situations, the external porosity is often in the range of about 30% to about 40%. As an example, the relatively low-porosity, high-density positive electrode composition may be very useful for end use applications in the telecommunications industry (discussed below), e.g., battery backup systems.

Various techniques can be used to increase the packing density of the granules within the electrode chamber. As an example, vibration, mechanical compaction, tapping; and combinations of these techniques may achieve some level of density. However, these techniques may not allow the degree of packing desired, and may cause other problems as well. For example, the vibration techniques, when applied to granules that have sharp angles or jagged edges and protruding regions, may knock off some of the smaller, protruding material, resulting in a residue that could adversely affect cathode function.

The granules of this invention permit the low porosity desired for some of these end use applications. As shown in FIG. 10, the spheroidal shape of the granules 99 permit them to more readily be “packed into” chamber 86. In this manner, the porosity region 81 can be minimized, and more granules can be incorporated into the chamber.

With continued reference to FIG. 10, the external porosity can be expressed in terms of the “tortuosity” within the collection of granules 99. Tortuosity can be generally defined as the ratio of the average distance that must be travelled between two points, to the shortest, straight-line distance between the two points. (Mathematically and geometrically, the term is sometimes expressed as the arc-chord ratio, i.e., the ratio of the length of a curve, to the distance between the ends of the curve).

Line-arrow 83 in FIG. 10 is used to illustrate the concept of tortuosity in simple form. In general, for many of the higher energy density embodiments, the tortuosity factor should be as low as possible. In other words, the path of electrical conduction between the granules should be a relatively short path. The spheroidal nature of the granules helps to ensure the low tortuosity.

Another embodiment of this invention is directed to an article that includes a positive electrode composition, as described herein. As one example, the article may be in the form of an energy storage device. The device usually comprises (a) a first compartment comprising an alkali metal; (b) a second compartment including a positive electrode composition, as described herein; and (c) a solid separator capable of transporting alkali metal ions between the first and the second compartments.

The device also includes a housing that usually has an interior surface defining a volume. A separator is disposed in the volume. The separator has a first surface that defines at least a portion of a first compartment, and a second surface that defines a second compartment. The first compartment is in ionic communication with the second compartment through the separator. As used herein, the phrase “ionic communication” refers to the traversal of ions between the first compartment and the second compartment, through the separator.

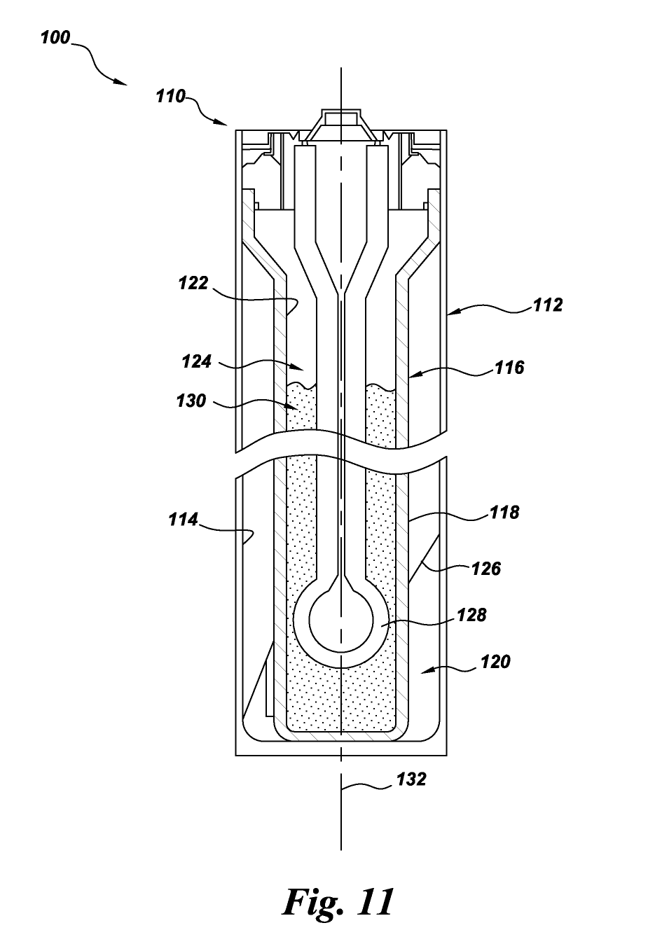

Referring to FIG. 11, an electrochemical cell 100 is provided. More particularly, a front cross-sectional view 110 of the cell is depicted. The electrochemical cell 100 includes a housing 112. The housing 112 usually has an interior surface 114, defining a volume. A separator 116 is disposed inside the housing 112. The separator 116 has a first surface 118 that defines a first compartment 120, e.g., usually the an anode compartment. The separator has a second surface 122 that defines a positive electrode compartment 124, as discussed previously. An anode current collector 126 (which may function as a shim, as well) is connected to the anode compartment 120. A positive electrode current collector 128 is usually connected to the positive electrode compartment 124. A positive electrode composition 130, described herein but detailed in other figures, is disposed inside the positive electrode compartment 124, as also described above. The working temperature of the electrochemical cell 100, when it is a sodium-nickel chloride cell, is usually about 250-350 degrees Celsius.

The housing of the electrochemical cell can be sized and shaped to have a cross-sectional profile that is square, polygonal, or circular, for example. Typically, the aspect ratio of the housing is determined by the aspect ratio of the separator. In many cases, the walls of the separator should be relatively slender, to reduce the average ionic diffusion path length. In one embodiment, the height to effective diameter ratio (2×(square root of (cross-sectional area/pi)) of the housing is greater than about 5. In some other embodiments, the ratio is greater than about 7. The housing can be formed from a material that is a metal, ceramic, or a composite; or some combination thereof. The metal can be selected from nickel or steel, as examples; and the ceramic is often a metal oxide.

Typically, the anode compartment is empty in the ground state (uncharged state) of the electrochemical cell. The anode is then filled with metal from reduced metal ions that move from the positive electrode compartment to the anode compartment through the separator, during operation of the cell. The anodic material, (e.g., sodium) is molten during use. The first compartment (usually the anode compartment) may receive and store a reservoir of anodic material.

Additives suitable for use in the anodic material may include a metallic oxygen scavenger. Suitable metal oxygen scavengers may include one or more of manganese, vanadium, zirconium, aluminum, or titanium. Other useful additives may include materials that increase wetting of the separator surface 116 defining the anode compartment, by the molten anodic material. Additionally, some additives or coatings may enhance the contact or wetting between the separator and the current collector, to ensure substantially uniform current flow throughout the separator.

The separator is usually an alkali metal ion conductor solid electrolyte that conducts alkali metal ions during use between the first compartment and the second compartment. Suitable materials for the separators may include an alkali-metal-beta-alumina, alkali-metal-beta″-alumina, alkali-metal-beta′-gallate, or alkali-metal-beta″-gallate. In various embodiments, the solid separator may include a beta′-alumina, a beta″-alumina, a gamma alumina, or a micromolecular sieve such as, for example, a tectosilicate, such as a feldspar, or a feldspathoid. Other exemplary separator materials include zeolites, for example a synthetic zeolite such as zeolite 3A, 4A, 13X, ZSM-5; rare-earth silicophosphates; silicon nitride; or a silicophosphate; a beta′-alumina; a beta″-alumina; a gamma alumina; a micromolecular sieve; or a silicophosphate (NASICON: Na₃Zr₂Si₂PO₁₂).

In some preferred embodiments, the separator includes a beta alumina. In one embodiment, a portion of the separator is alpha alumina, and another portion of the separator is beta alumina. The alpha alumina, a non-ionic-conductor, may help with sealing and/or fabrication of the energy storage device.

The separator can be sized and shaped to have a cross-sectional profile that is square, polygonal, circular, or clover leaf, to provide a maximum surface area for alkali metal ion transport. The separator can have a width to length ratio that is greater than about 1:10, along a vertical axis 132. In one embodiment, the length to width ratio of the separator is in a range of from about 1:10 to about 1:5, although other relative dimensions are possible, as described in Ser. No. 13/034,184. The ionic material transported across the separator between the anode compartment and the positive electrode compartment can be an alkali metal. Suitable ionic materials may include cationic forms of one or more of sodium, lithium and potassium.

The separator may be stabilized by the addition of small amounts of a dopant. The dopant may include one or more oxides selected from lithia, magnesia, zinc oxide, and yttria. These stabilizers may be used alone or in combination with themselves, or with other materials. In one embodiment, the separator comprises a beta alumina separator electrolyte (BASE), and may include one or more dopants.

As noted above, the separator is disposed within the volume of the housing 112. The separator may have a cross-sectional profile normal to a vertical axis 132 of the housing 112. Examples of profiles/shapes include a circle, a triangle, a square, a cross, a clover leaf, or a star. Alternatively, the cross-sectional profile of the separator can be planar about the vertical axis 132. A planar configuration (or one with a slight dome) may be useful in a prismatic or button-type battery configuration, where the separator is domed or dimpled. Similarly, the separator can be flat or undulated.

In one embodiment, the solid separator may include a shape which may be flat, undulated, domed or dimpled, or comprises a shape with a cross-sectional profile that may be an ellipse, triangle, cross, star, circle, cloverleaf, rectangular, square, or multi-lobal. The separator can be a tubular container in one embodiment, having at least one wall. The wall can have a selected thickness; and an ionic conductivity. The resistance across the wall may depend in part on that thickness. In some cases, the thickness of the wall can be less than about 5 millimeters. A cation facilitator material can be disposed on at least one surface of the separator, in one embodiment. The cation facilitator material may include, for example, selenium, as discussed in published U.S. Patent Application No. 2010/0086834, incorporated herein by reference.

In some embodiments, one or more shim structures can be disposed within the volume of the housing. The shim structures support the separator within the volume of the housing. The shim structures can protect the separator from vibrations caused by the motion of the cell during use, and thus reduce or eliminate movement of the separator relative to the housing. In one embodiment, a shim structure functions as a current collector.

In most embodiments, the energy storage device described herein may have a plurality of current collectors, including negative (e.g., anode) current collectors, and positive electrode current collectors. The anode current collector is in electrical communication with the anode chamber, and the positive electrode current collector is in electrical communication with the contents of the positive electrode chamber. Suitable materials for the anode current collector include iron, aluminum, tungsten, titanium, nickel, copper, molybdenum, and combinations of two or more of the foregoing metals. Other suitable materials for the anode current collector may include carbon. The positive electrode current collector may be in various forms, e.g., rod, a sheet, wire, paddle may or mesh, formed from platinum, palladium, gold, nickel, copper, carbon, or titanium. The current collector may be plated or clad. In one embodiment, the current collector is free of iron.

As described for some embodiments in U.S. application Ser. No. 13/034,184, referenced above, at least one of the alkali metals in the positive electrode may be sodium, and the separator may be beta-alumina. In another embodiment, the alkali metal may be potassium or lithium, with the separator then being selected to be compatible therewith. For example, in embodiments where the ions include potassium, silver, strontium, and barium cations, the separator material may include beta alumina. In certain other embodiments, where lithium cations are used, a lithiated borophosphate BPO₄—Li₂O, may be employed as the separator material.

A plurality of the electrochemical cells (each of which may be considered a rechargeable energy storage device) can be organized into an energy storage system, e.g., a battery. Multiple cells can be connected in series or parallel, or in a combination of series and parallel. For convenience, a group of coupled cells may be referred to as a module or pack. The ratings for the power and energy of the module may depend on such factors as the number of cells, and the connection topology in the module. Other factors may be based on end-use application specific criteria.

In some particular embodiments, the energy storage device is in the form of a battery backup system for a telecommunications (“telecom”) device, sometimes referred to as a telecommunication battery backup system (TBS). The device could be used in place of (or can complement) the well-known, valve-regulated lead-acid batteries (VRLA) that are often used in a telecommunications network environment as a backup power source. Specifications and other system and component details regarding TBS systems are provided from many sources, such as OnLine Power's “Telecommunication Battery Backup Systems (TBS)”; TBS-TBS6507A-8/3/2004 (8 pp); and “Battery Backup for Telecom: How to Integrate Design, Selection, and Maintenance” ; J. Vanderhaegen; 0-7803-8458-X/04, ©2004 IEEE (pp. 345-349). Both of these references are incorporated herein by reference.

In other embodiments, the energy storage device is in the form of an uninterruptable power supply device (UPS). The primary role of most UPS devices is to provide short-term power when the input power source fails. However, most UPS units are also capable in varying degrees of correcting common utility power problems, such as those described in patent application Ser. No. 13/034,184. The general categories of modern UPS systems are on-line, line-interactive, or standby. An on-line UPS uses a “double conversion” method of accepting AC input, rectifying to DC for passing through the rechargeable battery, then inverting back to 120V/230V AC for powering the protected equipment. A line-interactive UPS maintains the inverter in line and redirects the battery's DC current path from the normal charging mode to supplying current when power is lost. In a standby system, the load is powered directly by the input power; and the backup power circuitry is only invoked when the utility power fails. UPS systems including batteries having electrode compositions as described above may be ideal in those situations where high energy density within the battery is a requirement.

Another embodiment of this invention is directed to a method for the preparation of an energy storage device, as mentioned previously. In some specific embodiments, the method comprises providing a housing having an interior surface defining a volume; disposing a separator inside the housing, wherein the separator has a first surface that defines at least a portion of a first compartment, and a second surface that defines a second compartment. The first compartment is in ionic communication with the second compartment through the separator. The method includes the step of preparing a positive electrode composition (as described previously), comprising granules of a substantially spheroidal shape; and disposing this material in the second compartment. Other steps to fully fabricate the device can then be undertaken, e.g., filling the cathode compartment with electrolyte, compartment-sealing steps, electrical connection steps, and the like. The method may include taking the battery or other type of energy storage device through a plurality of charge/discharge cycles, to activate or condition the positive electrode composition material.

The energy storage devices illustrated herein may be rechargeable over a plurality of charge-discharge cycles. In another embodiment, the energy storage device may be employed in a variety of applications; and the plurality of cycles for recharge is dependent on factors such as charge and discharge current, depth of discharge, cell voltage limits, and the like.

The energy storage system described herein can usually store an amount of energy that is in a range of from about 0.1 kiloWatt hours (kWh) to about 100 kWh. An illustration can be provided for the case of a sodium-nickel chloride energy storage system (i.e., a battery) with a molten sodium anode and a beta-alumina solid electrolyte, operating within the temperature range noted above. In that instance, the energy storage system has an energy-by-weight ratio of greater than about 100 Watt-Hours per kilogram, and/or an energy-by-volume ratio of greater than about 200 Watt-Hours per liter. Another embodiment of the energy storage system has a specific power rating of greater than about 200 Watts per kilogram; and/or an energy-by-volume ratio of greater than about 500 Watt-Hours per liter. The power-to-energy ratio is usually in the range of about 1:1 hour⁻¹ to about 2:1 hour⁻¹. (It should be noted that the energy term here is defined as the product of the discharge capacity multiplied by the thermodynamic potential. The power term is defined as the power available on a constant basis, for 15 minutes of discharge, without passing through a voltage threshold sufficiently low to reduce the catholyte).

Other features associated with the energy storage system may constitute embodiments of this invention; and some are described in the referenced application Ser. No. 13/034,184. As an example, the system can include a heat management device, to maintain the temperature within specified parameters. The heat management device can warm the energy storage system if too cold, and can cool the energy storage system if too hot, to prevent an accelerated cell degradation. The heat management system includes a thaw profile that can maintain a minimal heat level in the anode and positive electrode chambers, to avoid freezing of cell reagents.

Some other embodiments are directed to an energy management system that includes a second energy storage device that differs from the first energy storage device. This dual energy storage device system can address the ratio of power to energy, in that a first energy storage device can be optimized for efficient energy storage, and the second energy storage device can be optimized for power delivery. The control system can draw from either energy storage device as needed, and charge back either energy storage device that needs such a charge.

Some of the suitable second energy storage devices, for the power platform, include a primary battery, a secondary battery, a fuel cell, and/or an ultracapacitor. A suitable secondary battery may be a lithium battery, lithium ion battery, lithium polymer battery, or a nickel metal hydride battery.

### EXAMPLES

The examples presented below are intended to be merely illustrative, and should not be construed to be any sort of limitation on the scope of the claimed invention. Unless specified otherwise, all of the components are commercially available from common chemical suppliers.

A sodium chloride/nickel based energy storage cell was assembled, using the following materials:

TABLE 1

| Material | Source | Properties |
|---|---|---|
| Nickel 255 (metal | Inco Special | 97.9 percent pure, 0.6 square |
| nickel powder, | products | meters per gram surface area, |
| Ni) | | 2.2 to 2.8 micrometers |
| | | particle size) |
| Sodium Chloride | Custom Powders | 99.99 percent pure |
| (NaCl) | Ltd, UK | |
| Iron (metal iron | Alfa Aesar Item | less than 10 micrometers particle |
| powder) (Fe) | #00170, | size, 99.9 percent pure |
| Aluminum | Alfa Aesar Item | −100 + 325 mesh particle size, |
| powder (Al) | #42919 | 99.97 percent pure |
| Sodium Fluoride | Sigma Aldrich | ~99 percent pure |
| (NaF) | | |
| Sodium iodide | Sigma Aldrich | ~99 percent pure |
| (NaI) | | |

The sodium chloride (NaCl) was heat-treated at 220° C. under vacuum, and milled to an average particle size of 90 percent less than 75 micrometers in a laboratory mill, in a dry glove box. Positive electrode materials, including metal nickel powder, sodium chloride, sodium fluoride, sodium iodide, iron, and aluminum powder were pressed at ambient room temperature (typically about 18° C.-25° C.), under a linear pressure of about 110 bar to about 115 bar, using an Alexanderwerk WP50N/75 Roll Compactor/Milling Machine. The pressurized material for the positive electrode was ground under a rotating mill into granules; and the fraction containing a particle size of about 0.325 to about 1.5 millimeters was used for the cell assembly.

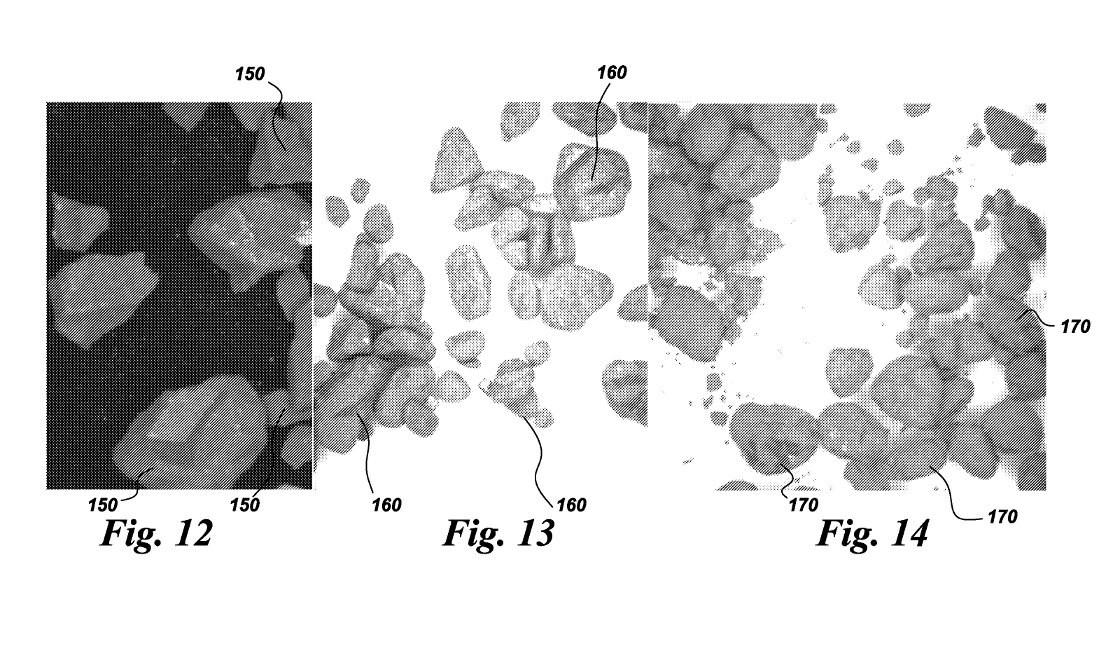

FIG. 12 is a photomicrograph (magnified) of a collection of granules 150. The granules had been subjected to the compacting/milling steps mentioned above, but had not been subjected to spheronization. As shown in the figure, the granules had an irregular, multi-faceted shape, with relatively sharp edges. (In this instance, the granules were also somewhat “pancake”-shaped as well).

Prior to being used in the cell, the positive electrode granules were subjected to spheronization, using a rotating friction disk-type of spheronizer, similar to the apparatus described above. The spheronizer was operated with a 250 mm disc that had a square pattern of triangular notches. The grooves were spaced about 3-4 mm apart, center-to-center, and were approximately 1.5-2.0 mm deep. The spheronization speed was about 800-1800 rpm.

FIG. 13 is a photomicrograph (magnified) of some of the granules 160 of FIG. 12, after being subjected to the spheronization step, for 5 minutes. In this instance, the granules 160 are slightly rounder than those of FIG. 12. The granules retain some of the sharper angles and pointed vertices, but less so than granules 150.

FIG. 14 is another photomicrograph (magnified) of some of the granules 170 of FIG. 13, after a 15 minute period of spheronization. In this case, almost all of the granules have obtained a spherical shape. They are also generally free of any sharp angles and jagged edges.

In continuing with the preparation of the energy storage system, the electrolyte salt, sodium tetrachloroaluminate (NaAlCl₄), was prepared, by mixing and melting together sodium chloride and aluminum chloride. (The aluminum chloride was volatile when melted, so mixing and melting of the electrolyte salt was done as a separate step, before electrochemical cell fabrication). Preparation of the electrolyte salt was carried out in a nitrogen purge box, to keep the materials dry. To produce a 750 gram batch of NaCl-rich (basic) sodium tetrachloroaluminate, 500 grams of aluminum chloride and 250 grams of sodium chloride were mixed in a 500-milliliter reaction vessel. The reaction vessel was sealed with a clamped lid equipped with a gas outlet that was connected to a mineral oil bubbler to relieve any pressure.

The reaction vessel containing the dry powders was heated to 330° C., which was above the melting point of the electrolyte salt mixture. Once melted, about 5-10 grams of aluminum powder was introduced to the molten salt. The aluminum powder, which oxidizes readily, acts to scavenge impurities present in the raw materials.

Once melted, with impurities precipitated out, the sodium tetrachloroaluminate was filtered to remove the aluminum powder and the precipitates. The molten salt was filtered through a heated (from about 200-300° C.) glass frit (25 micrometers minimum pore size). The filtered molten salt was collected on aluminum foil. Once the filtered molten salt had solidified, it was manually chipped into smaller pieces, and then milled in a dedicated, laboratory-scale, grinding mill for 60 seconds. The sodium tetrachloroaluminate powder was stored in a glove box for use in cell fabrication as an electrolyte salt. Optionally, where needed, a portion of the sodium tetrachloroaluminate powder was combined with nickel chloride salt and sodium chloride, to produce a ternary electrolyte, which was stored in a glove box for use in cell fabrication. (The electrolyte may be prepared in a manner discussed herein, or can be directly obtained from Sigma Aldrich).

An electrochemical cell similar to that of FIG. 11 was assembled; and reference to the figure (cell 100) will be made here, to aid in this description. (All cells were assembled in the discharged state.) The separator tubes 116 for the cell 100, cylindrical or cloverleaf in shape, were produced according to known methods; or were commercially obtained. Each tube 116 was formed from ceramic sodium conductive beta″-alumina. The cylinder dimensions were 228 millimeters length, 36 millimeters, internal diameter, and 38 millimeters, outside diameter. These are dimensions from lobe tip to lobe tip, when a clover leaf shaped separator tube was employed. Each ceramic separator tube was glass sealed to an alpha alumina collar, to form an assembly. Each assembly was placed in a stainless steel housing 112 that served as the housing to form an electrochemical cell. The housing size was about 38 millimeters×38 millimeters×230 millimeters.

The electrode composition granules prepared using the procedure mentioned above, were placed in the β″-alumina tube. The β″-alumina tube was pre-assembled with an anode chamber and a positive electrode current collector, and densified by vibration on a vibratory shaker in a nitrogen filled glove box. The positive electrode was then injected with the molten sodium tetrachloroaluminate NaAlCl₄ (as prepared above), under vacuum at 280° C. Following this, the cell cap was welded at a temperature of about 230° C. inside the glove box, using a commercial welding system, with an ultra-high purity argon purge. The cell was then tested for leaks.

Cell testing was carried out, according to a standard protocol described in the referenced application Ser. No. 13/034,184, using a 100 A, 10V, multi-channel Digatron BTS600 battery testing system. The testing protocol involved a series of charging and discharging cycles, with a corresponding regimen of current, voltage, and temperature adjustments (approximately 225 cycles in all). For each composition described below, the charge capacity was measured, in terms of a “maiden charge”, which was initiated at low current, to avoid excessive current densities during the initial production of sodium in the negative electrode. For each composition, three cells were usually tested, using the testing protocol.

The positive electrode granules prepared as described above were examined for packing density. In some cases, the packing density was measured by vibrating a weighted quantity of granules in a graduated cylinder for a specific time, and then recording the volume occupied by the granules. In other cases, a Micromeritics Geopyc 1360T machine was used to evaluate packing density (in a TAP density operation mode). By this technique, a weighed quantity of granules is placed in a specific, volumetric cell. The machine rotates the granules in the cylindrical cell, while pushing forward with a plunger. The plunger has a load cell attached to it. When 10N of force is achieved, consolidating the granules to a specific volume, the device records the volume and the TAP density.

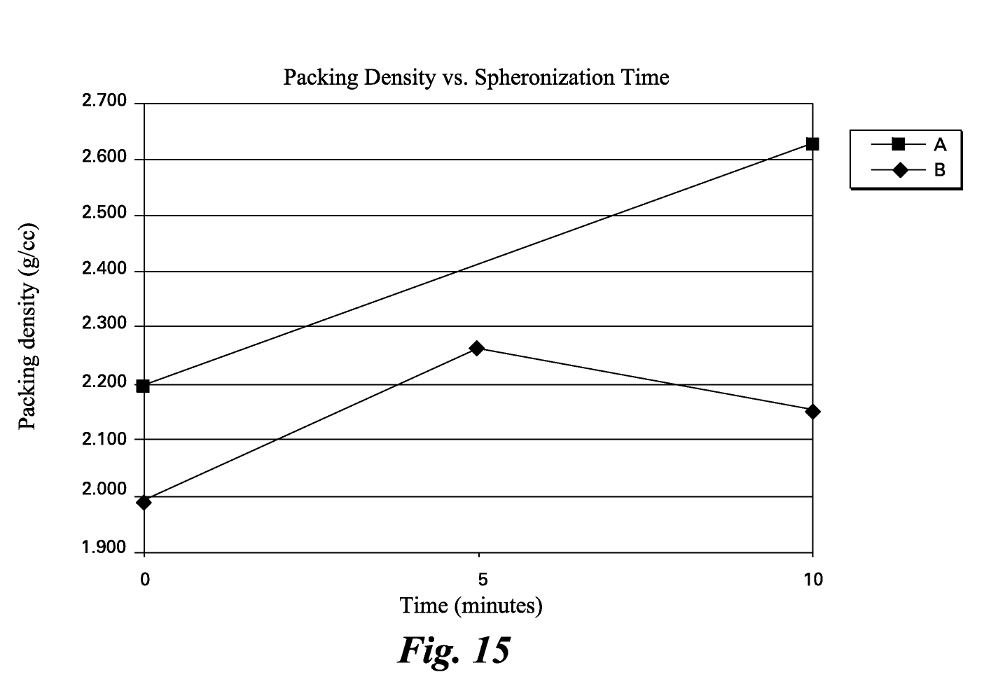

FIG. 15 is a graph representing packing density as a function of spheronization time, for two samples. The granules for this particular experiment had a composition as follows: 27 wt % NaCl; 65 wt % nickel, 5.4 wt % iron; and 2.6% of an additive combination of Al, NaF, and NaI. The granules of sample A were quite large, having a dimension greater than about 2.0 mm in at least one direction. They had been made from a ribbon of about 1.0 mm in size, and had a shape similar to a fractured wafer or “pancake”. The granules of sample B had a typical, fractured-crystal shape like that shown in FIG. 12.

The initial packing density for samples A and B, prior to any spheronization, was 2.2 g/cc³ and about 2.0 g/cc³, respectively. Granules subjected to spheronization for 5 minutes showed a density of 2.26 g/cc³ for sample B (no specific reading was obtained at the 5 minute mark for sample A). After 10 minutes, sample A achieved a packing density of 2.6 g/cc³, while sample B achieved a packing density of about 2.16 g/cc³. It is clear that an increase in packing density of about 20% is possible.

The packing density of sample B had decreased somewhat at the 10 minute mark. It is thought that spheronization conditions and duration were perhaps excessive in this experimental run, leading to the formation of more “powdery” content, that would not pack as well. However, it should be noted that the sample B material still exhibited a packing density increase, as compared to its characteristics prior to any spheronization.

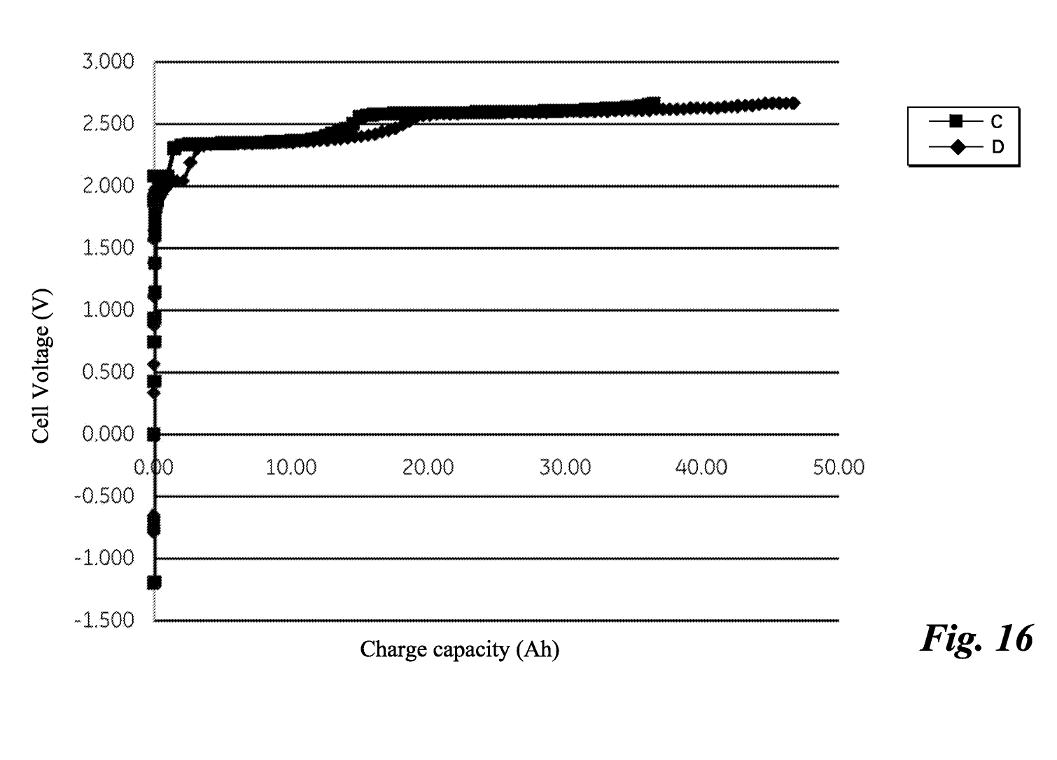

Some of the samples prepared above were then used as the positive electrode composition in an electrochemical cell prepared, assembled, and tested as described previously. FIG. 16 is a graph representing cell voltage, as a function of charge capacity. Sample C represents the baseline material, i.e., without spheronization, wherein 285 grams of granules could be packed into a standard cathode compartment. Sample D represents the spheroidal material (10 minutes of spheronization), wherein 342 grams of the granules could be packed into the cathode compartment.

The data of FIG. 16 demonstrate that an increase in the loading of the positive electrode in the cell results in an increase in charge capacity, from 38 amp hours to 47 amp hours. The actual charge capacity for an electrochemical cell may vary significantly, based on many of the factors described above. (This particular comparison was directed mainly toward the packing-density phenomenon, and not necessarily toward the optimization of device performance. Similar devices that were made exceeded the charge capacity values listed in FIG. 16). Moreover, it is believed that the lower tortuosity path for the spheronized cathode particles can result in an increase in the power-performance of the cell as well.

The present invention has been described in terms of some specific embodiments. They are intended for illustration only, and should not be construed as being limiting in any way. Thus, it should be understood that modifications can be made thereto, which are within the scope of the invention and the appended claims. Furthermore, all of the patents, patent applications, articles, and texts which are mentioned above are incorporated herein by reference.

What is claimed:

1. A positive electrode composition, comprising granules of at least one electroactive metal and at least one alkali metal halide, wherein the granules have a substantially spheroidal shape.

2. The composition of claim 1, wherein substantially all of the granules are free of sharp angles and jagged edges.

3. The composition of claim 1, wherein the granules are substantially spherical.

4. The composition of claim 1, wherein the granules have an average effective diameter in the range of about 100 microns to about 5,000 microns.

5. The composition of claim 1, wherein the granules within the composition conform to a bimodal distribution in size (diameter).

6. The composition of claim 5, wherein the ratio of the granule diameters (weight-average) in the bimodal distribution is in a range from about 1 to 0.1, to about 1 to 0.005.

7. The composition of claim 1, wherein the granules have an average internal porosity in the range of about 5% to about 30%.

8. The positive electrode composition of claim 1, having an external porosity of about 25% to about 70%.

9. The composition of claim 1, wherein the electroactive metal is selected from the group consisting of titanium, vanadium, niobium, molybdenum, nickel, cobalt, chromium, copper, manganese, silver, antimony, cadmium, tin, lead, iron, zinc, and combinations thereof.

10. The composition of claim 1, wherein the alkali metal halide comprises at least one halide of sodium, potassium, or lithium.

11. The composition of claim 1, comprising sodium iodide.

12. The composition of claim 1, further comprising at least one electrolyte salt.

13. An article, comprising a positive electrode; which itself comprises granules of at least one electroactive metal and at least one alkali metal halide, wherein the granules have a substantially spheroidal shape.

14. The article of claim 13, in the form of an energy storage device or an uninterruptable power supply (UPS) device.

15. An energy storage device, comprising:
a) a first negative compartment comprising an alkali metal;
b) a negative electrode current collector
c) a second compartment comprising a positive electrode composition that itself comprises granules of at least one electroactive metal and at least one alkali metal halide, wherein the granules have a substantially spheroidal shape;
d) a positive electrode current collector; and
e) a solid separator capable of transporting alkali metal ions between the first and the second compartments.

16. The device of claim 15, characterized as being rechargeable over a plurality of cycles.

17. An energy storage battery comprising a plurality of rechargeable energy storage devices in accordance with claim 15.

18. A telecommunications device that comprises a battery backup system, said battery system comprising a plurality of rechargeable energy storage devices, wherein at least some of the storage devices comprise:
a) a first negative compartment comprising an alkali metal;
b) a negative electrode current collector;
c) a second compartment comprising a positive electrode composition that itself comprises granules of at least one electroactive metal and at least one alkali metal halide, wherein the granules have a substantially spheroidal shape;
d) a positive electrode current collector; and
e) a solid separator capable of transporting alkali metal ions between the first and the second compartments.

19. A method for the preparation of an energy storage device, comprising
A) providing a positive electrode and a negative electrode, ionically connected to each other by a separator, and capable of reacting galvanically upon connection;
B) providing an electrically-conductive electrolyte to at least the positive electrode; and
C) providing positive and negative current collectors for attachment to the positive and negative electrodes, respectively, to direct current resulting from the galvanic reaction to a desired location;
wherein the positive electrode comprises granules having a substantially spherical shape.
